(19) United States
(12) Patent Application Publication
(10) Pub. No.: US 2016/0167599 A1
(43) Pub. Date: Jun. 16, 2016

(54) License Plate Holder

(71) Applicant: Cecil Clarke, North Miami, FL (US)

(72) Inventor: Cecil Clarke, North Miami, FL (US)

(21) Appl. No.: 14/837,772

(22) Filed: Aug. 27, 2015

Related U.S. Application Data
(60) Provisional application No. 62/092,445, filed on Dec. 16, 2014.

(51) Int. Cl. B60R 13/10

(52) U.S. Cl. CPC B60R 13/105

(57) ABSTRACT

A license plate holder having an enlarged area for advertising material and other indicia. The license plate holder includes a frame for a license plate and that can be secured thereto. The frame is substantially rectangular in configuration and includes a first side, a second side, an upper end, and a lower end defining a central opening. The lower end of the frame extends below the license plate held therein and includes an enlarged area for advertising material. The license plate holder further includes a plurality of openings adapted to align with openings on the license plate for securing the license plate holder thereto via fasteners, such as screws.

### CROSS REFERENCE TO RELATED APPLICATION

This application claims the benefit of U.S. Provisional Application No. 62/092,445 filed on Dec. 16, 2014. The above identified patent application is herein incorporated by reference in its entirety to provide continuity of disclosure.

### BACKGROUND OF THE INVENTION

1. FIELD OF THE INVENTION

The present invention relates to a license plate holder. More specifically, the present invention provides a license plate holder configured to provide space for advertising and other indicia thereon without obscuring the information displayed on the license plate. The license plate holder comprises a rectangular frame having a central opening and further having an enlarged area on the lower end thereof, wherein the enlarged area is adapted to extend below the lower end of the license plate. In this way, the enlarged area does not obscure information on the lower end of the license plate and provides space for advertising materials.

License plate holders or frames are commonly applied to license plates to provide a decorative or ornamental appearance for the license plate. License plate holders generally comprise a thin frame that surrounds the perimeter of the license plate so as to provide an aesthetically pleasing border for the license plate. Further, such license plate holders can be composed of various materials and may have any of various colors.

Additionally, some license plate holders comprise advertising material or other indicia thereon, such as university names, vehicle dealership names, sports team names and logos, among others. However, conventional license plate holders do not provide much room for advertising materials and indicia to be printed thereon, and as a result the advertising material may be small and not readily viewable by third parties. Some license plate holders include special regions for advertising materials, but such regions may obscure or cover part of the license plate. Covering information on the license plate is undesirable and may result in the driver violating a traffic regulation and receiving a fine. Thus, a license plate holder having space for advertising material thereon without obscuring the information on the license plate is desired.

Devices have been disclosed in the prior art that relate to license plate holders. These include devices that have been patented and published in patent application publications. These devices generally relate to license plate covers having means for carrying advertising materials, such as U.S. Pat. No. 2,093,620, U.S. Pat. No. 2,815,598, U.S. Design Patent Number D175,144, U.S. Pat. No. 2,618,089, and U.S. Published Patent Application Number 2006/0075665.

These prior art devices have several known drawbacks. The license plate holders in the prior art provide frames having areas for advertising materials, wherein the additional areas extend outwardly from an upper portion of the frame. As a result, the license plate holder does not include the traditional rectangular shape, and instead includes a protrusion from a portion thereof that may be undesirable or aesthetically unappealing. Further, some license plate holders provide advertising space that covers or obscures portions of the license plate, which is also undesirable. Thus, the devices in the prior art fail to provide a license plate holder having an enlarged area on the lower end thereof that extends below the lower end of a license plate held therein so as to provide space for advertising materials without obscuring the license plate.

In light of the devices disclosed in the prior art, it is submitted that the present invention substantially diverges in design elements from the prior art and consequently it is clear that there is a need in the art for an improvement to existing license plate holding devices. In this regard the instant invention substantially fulfills these needs.

### SUMMARY OF THE INVENTION

In view of the foregoing disadvantages inherent in the known types of license plate holders now present in the prior art, the present invention provides a new license plate holder wherein the same can be utilized for providing convenience for the user when providing a license plate holder having space for advertising materials or other indicia thereon without blocking or covering information displayed on the license plate.

It is therefore an object of the present invention to provide a new and improved license plate holder comprising a frame having an enlarged lower end so as to create space for advertising material thereon.

It is another object of the present invention to provide a license plate holder comprising a frame with a plurality of openings adapted to be aligned with openings on a license plate so that a fastener can be inserted therethrough for securing the license plate holder to the license plate.

Another object of the present invention is to provide a license plate holder comprising a rectangular frame adapted to be disposed about the perimeter of a license plate.

Yet another object of the present invention is to provide a license plate holder that does not cover or obscure information displayed on the license plate.

Another object of the present invention is to provide a license plate holder that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the license plate holder of the present invention.

FIG. 2 shows a front view of the license plate holder of the present invention as secured to a license plate.

### DETAILED DESCRIPTION OF THE INVENTION

Reference is made herein to the attached drawings. Like reference numerals are used throughout the drawings to depict like or similar elements of the license plate holder. For the purposes of presenting a brief and clear description of the present invention, the preferred embodiment will be discussed as used for providing a decorative border for a license plate that provides room for advertising materials without covering the information displayed on the license plate. The figures are intended for representative purposes only and should not be considered to be limiting in any respect.

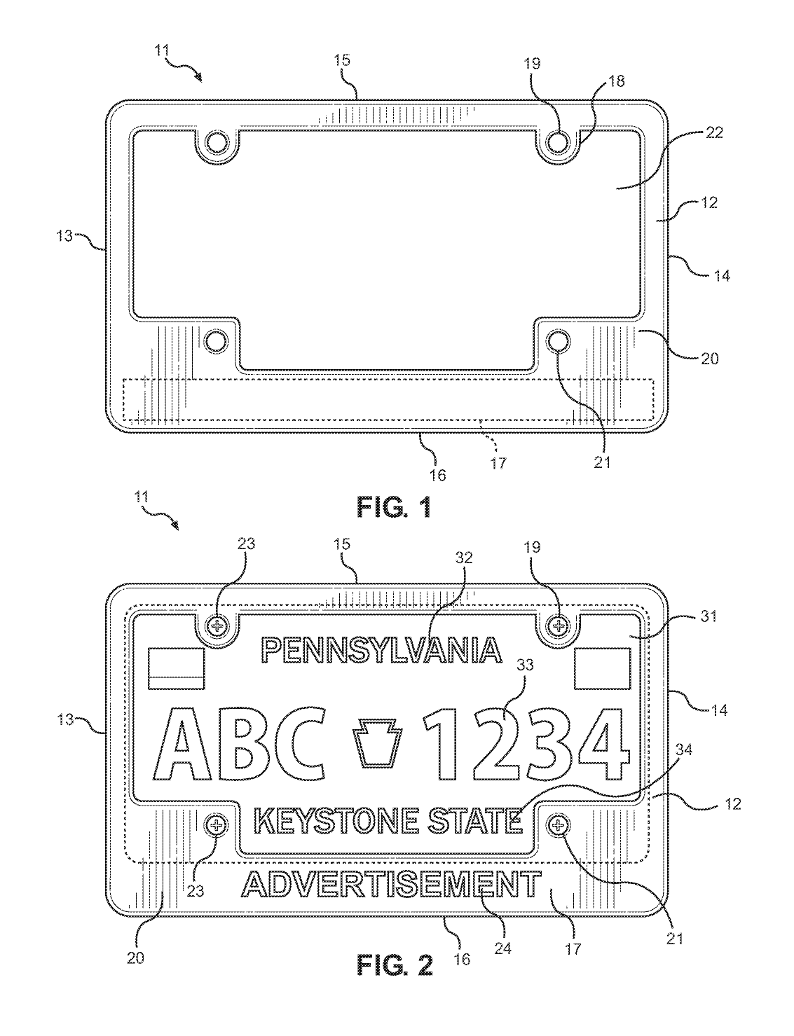

Referring now to FIG. 1, there is shown a front view of the license plate holder of the present invention. The license plate holder 11 comprises a frame 12 having a first end 13, a second end 14, an upper end 15, and a lower end 16. The frame 12 is substantially rectangular and is sized similarly to a conventional license plate. The frame 12 includes a central opening 22 so as to allow the information on the license plate to be displayed without obstruction. Further, the frame 12 is substantially planar so that the frame 12 can rest flush against a license plate. The frame 12 comprises a narrow section along the first end 13, second end 14, and upper end 15 of the frame 12. In this way, the frame 12 is disposed along the perimeter of a license plate held therein and does not obscure information displayed on the license plate.

The lower end 16 of the frame 12 comprises an enlarged area 17. The enlarged area 17 that extends downwardly from the central opening 22. Thus, the license plate holder 11 retains a rectangular configuration, wherein the lower end 16 of the frame 12 is enlarged relative to the first end 13, second end 14, and upper end 15 of the frame 12. The enlarged area 17 serves as a space for advertising material or other indicia. The enlarged area 17 extends between the lower edge of the frame 12 and the central opening 22 so that the enlarged area 17 does not cover any portion of the license plate held within the license plate holder 11.

The license plate holder 11 further comprises a plurality of openings 19, 21 thereon. The plurality of openings 19, 21 are adapted to be aligned with the openings on a license plate so that a fastener, such as a screw, can be inserted therethrough in order to secure the license plate holder 11 to the license plate and to the vehicle. In the illustrated embodiment, the upper end 15 includes a pair of downwardly extending tabs 18 each having a single opening 19 thereon. Thus, the pair of tabs 18 extend into the central opening 22 of the frame 12. The lower end 16 of the frame 12 includes a pair of upwardly extending tabs 20. In the illustrated embodiment, the upwardly extending tabs 20 are positioned at the intersection of the lower end 16 and the first end 13 and with the second end 14, respectively. In this way, the upwardly extending tabs 20 are positioned on the bottom left and bottom right corners of a license plate held within the license plate holding device 11. Each upwardly extending tab 20 includes an opening 21 thereon. Preferably, the openings 19 on the upper end 15 are vertically aligned with the openings 21 on the lower end 16 of the license plate holder 11.

Referring now to FIG. 2, there is shown a front view of the license plate holder of the present invention as secured to a license plate. In operation, a user can secure a license plate 31 to the license plate holder 11 by aligning the openings 19, 21 on the license plate holder 11 with the openings on the license plate 31 and inserting a fastener 23, such as a screw therethrough. The license plate holder 11 rests on the front surface of the license plate 31. The first end 13, upper end 15, and second end 14 of the license plate holder 11 extend along the perimeter of the license plate 31. The license plate number 33, state name 32, state nickname 34, and vehicle registration sticker, or other information can be clearly seen through the central opening of the license plate holder 11. The lower end 16 extends along the lower edge of the license plate 31 so as to not obscure any information thereon.

The enlarged area 17 of the lower end 16 extends below the lower edge of the license plate 31 so as to provide space for advertising without covering the license plate 31. The enlarged area 17 provides a substantially rectangular area beneath the license plate 31 on which any of various advertisements 24 or indicia can be displayed, such as business names and logos, college or university names and logos, or sports team names and logos, among others. Thus, the license plate holder 11 comprises a substantially rectangular shape so as to resemble a conventional license plate holder, wherein the license plate holder 11 includes an enlarged area 17 for advertising materials that extends below the license plate 31 held therein so as to not obscure any information on the license plate 31.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A license plate holder, comprising:
a frame having a first end, a second end, an upper end, and a lower end defining an open central area;
an enlarged area on said lower end of said frame;
a plurality of openings disposed on said frame adapted for removably securing said frame to a license plate via a fastener.

2) The license plate holder of claim 1, wherein said frame is substantially rectangular.

3) The license plate holder of claim 1, wherein said frame further comprises one or more downwardly extending tabs on said upper end, wherein said plurality of openings are located on said one or more downwardly extending tabs.

4) The license plate holder of claim 1, wherein said frame further comprises one or more upwardly extending tabs on said lower end, wherein said plurality of openings are located on said one or more upwardly extending tabs.

5) The license plate holder of claim 1, wherein said enlarged area is substantially rectangular.

6) The license plate holder of claim 1, wherein said enlarged area is adapted to extend below said license plate held within said frame such that said enlarged area does not cover said license plate.

7) The license plate holder of claim 1, wherein said frame is substantially flat.
